(19) United States
(12) Patent Application Publication
(10) Pub. No.: US 2025/0008062 A1
(43) Pub. Date: Jan. 2, 2025

(54) ILLUMINATOR AND PROJECTOR

(71) Applicant: SEIKO EPSON CORPORATION, Tokyo (JP)

(72) Inventor: Koichi AKIYAMA, AZUMINO-SHI (JP)

(21) Appl. No.: 18/759,203

(22) Filed: Jun. 28, 2024

(30) Foreign Application Priority Data
Jun. 30, 2023 (JP) 2023-107972

(51) Int. Cl. H04N 9/31

(52) U.S. Cl. CPC H04N 9/3152; H04N 9/3155

(57) ABSTRACT

An illuminator includes a first light source that emits first light; a second light source that emits second light; a light combining member that combines the first light and the second light with each other and emits combined light; a first diffuser including a first substrate having a first diffusion surface that diffuses the combined light incident thereon and emits diffused combined light, and a first driver that rotates the first substrate; a light collector that is disposed between the light combining member and the first diffuser and collects the combined light at the first diffusion surface of the first diffuser; a collimator that parallelizes the combined light emitted from the first diffuser; and a second diffuser that is disposed between the light collector and the first diffuser and temporally changes the state of a spot of the combined light at the first diffusion surface.

The present application is based on, and claims priority from JP Application Serial Number 2023-107972, filed Jun. 30, 2023, the disclosure of which is hereby incorporated by reference herein in its entirety.

### BACKGROUND

### 1. Technical Field

The present disclosure relates to an illuminator and a projector.

### 2. Related Art

In recent years, to enhance the performance of projectors, there has been a proposed projector including an illuminator including a laser light source, which is a light source that has a wide color gamut and operates at high efficiency, and a projector including the illuminator.

For example, in the projector disclosed in JP-A-2019-078906, three types of color light output from a red light source array including laser light sources that each output red light, a green light source array including laser light sources that each output green light, and a blue light source array including laser light sources that each output blue light are combined with each other by a light combining system, and the combined light enters a light collection lens, which collects the combined light and outputs the collected combined light toward a diffusion plate. In the projector disclosed in JP-A-2019-078906, the collected combined light passes through the diffusion plate, which reduces speckle noise that appears in a projection image.

JP-A-2019-078906 is an example of the related art.

In the projector disclosed in JP-A-2019-078906, merely irradiating the diffusion plate with the combined light collected by the light collection lens and outputting the diffused combined light from the diffusion plate does not sufficiently reduce the speckle noise, and it is desired to improve the speckle noise reduction.

### SUMMARY

An illuminator according to an aspect of the present disclosure includes a first light source that emits first light having a first wavelength; a second light source that emits second light having a second wavelength different from the first wavelength; a light combining member that combines the first light and the second light with each other and emits combined light; a first diffuser including a first substrate having a first diffusion surface that diffuses the combined light incident thereon and emits diffused combined light, and a first driver that rotates the first substrate; a light collector that is disposed between the light combining member and the first diffuser and collects the combined light at the first diffusion surface of the first diffuser; a collimator that parallelizes the combined light emitted from the first diffuser; and a second diffuser that is disposed between the light collector and the first diffuser and temporally changes the state of a spot of the combined light at the first diffusion surface.

### BRIEF DESCRIPTION OF THE DRAWINGS

FIG. 1 is a schematic view showing the configuration of a projector according to an embodiment.

FIG. 2 is a schematic view of an illuminator of the projector shown in FIG. 1.

FIG. 3 is a schematic view of a substrate of a first diffuser of the illuminator shown in FIG. 2 viewed along the axis of rotation of the substrate.

FIG. 4 is a schematic view of a substrate of a second diffuser of the illuminator shown in FIG. 2 viewed along the axis of rotation of the substrate.

FIG. 5 is a beam distribution diagram derived by Numerical Calculation Example 1 to the relating illuminator shown in FIG. 2.

FIG. 6 is a beam distribution diagram derived by Numerical Calculation Example 2 relating to the illuminator shown in FIG. 2.

FIG. 7 is a beam distribution diagram derived by Numerical Calculation Example 3 relating to the illuminator shown in FIG. 2.

FIG. 8 is a beam distribution diagram derived by Numerical Calculation Example 4 relating to the illuminator shown in FIG. 2.

FIG. 9 is a beam distribution diagram derived by Numerical Calculation Example 5 relating to the illuminator shown in FIG. 2.

FIG. 10 is a beam distribution diagram derived by Numerical Calculation Example 6 relating to the illuminator shown in FIG. 2.

FIG. 11 is a beam distribution diagram derived by Numerical Calculation Example 7 relating to the illuminator shown in FIG. 2.

FIG. 12 is a beam distribution diagram derived by Numerical Calculation Example 8 relating to the illuminator shown in FIG. 2.

FIG. 13 is a schematic view of the substrate according to a first variation of the first diffuser of the illuminator shown in FIG. 2.

FIG. 14 is a schematic view of the substrate according to a second variation of the first diffuser of the illuminator shown in FIG. 2.

FIG. 15 is a schematic view of the substrate according to a third variation of the first diffuser of the illuminator shown in FIG. 2.

### DESCRIPTION OF EMBODIMENTS

An embodiment of the present disclosure will be described below with reference to the drawings. In the drawings, components are drawn at different dimensional scales in some cases for clarification of each of the components.

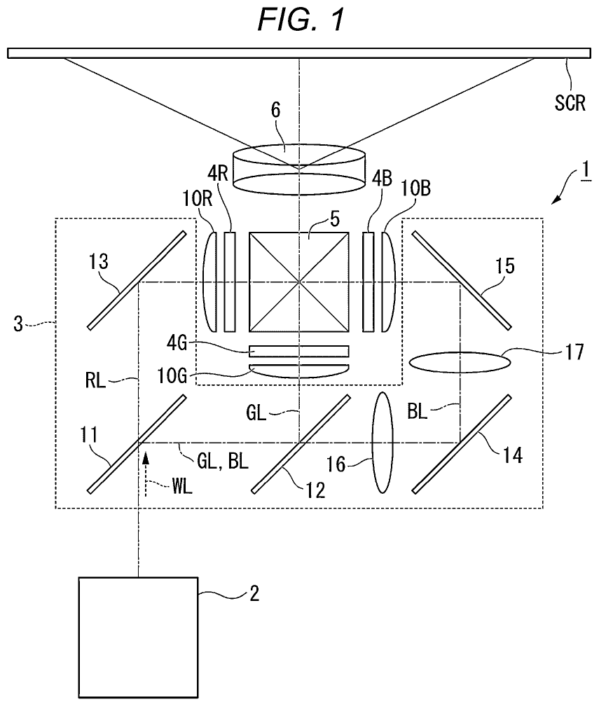

A projector according to an embodiment of the present disclosure will first be described with reference to FIG. 1. FIG. 1 is a schematic view showing the configuration of a projector 1 according to the embodiment of the present disclosure. The projector 1 is a projection-type image display apparatus that displays video images on a screen SCR. The projector 1 includes an illuminator 2, a color separation system 3, light modulators 4R, 4G, and 4B, a light combining system 5, and a projection system 6. The projector 1 is a three-panel projector including three light modulators.

The illuminator 2 outputs white light WL toward the color separation system 3. The white light WL is illumination light used in the projector 1, and contains red light RL, green light GL, and blue light BL. The configuration of the illuminator 2 will be described later.

The color separation system 3 separates the white light WL into the red light RL, the green light GL, and the blue light BL. The color separation system 3 includes, for example, a first dichroic mirror 11, a second dichroic mirror 12, a first total reflection mirror 13, a second total reflection mirror 14, a third total reflection mirror 15, a first relay lens 16, and a second relay lens 17.

The first dichroic mirror 11 is disposed in the optical path of the white light WL output from the illuminator 2, and separates the incident white light WL into the red light RL and light containing the green light GL and the blue light BL. The first dichroic mirror 11 transmits the red light RL and reflects the green light GL and the blue light BL. The second dichroic mirror 12 is disposed in the optical path common to the green light GL and the blue light BL output from the first dichroic mirror 11, and separates the green light GL and the blue light BL from each other. The second dichroic mirror 12 transmits the blue light BL and reflects the green light GL.

The first total reflection mirror 13 reflects the red light RL toward the light modulator 4R. The second total reflection mirror 14 and the third total reflection mirror 15 guide the blue light BL to the light modulator 4B. The green light GL is reflected off the second dichroic mirror 12 toward the light modulator 4G. The red light RL, the green light GL, and the blue light BL contained in the white light WL correspond to the light output from the illuminator 2.

The first relay lens 16 is disposed in the optical path of the blue light BL between the second dichroic mirror 12 and the second total reflection mirror 14. The second relay lens 17 is disposed in the optical path of the blue light BL between the second total reflection mirror 14 and the third total reflection mirror 15. The arrangement of the first relay lens 16 and the second relay lens 17 described above compensates for optical loss of the blue light BL. The optical loss of the blue light BL is caused by the fact that the optical path length of the blue light BL from the first dichroic mirror 11 to the light modulator 4B is longer than the optical path length of the red light RL from the first dichroic mirror 11 to the light modulator 4R and the optical path length of the green light GL from the first dichroic mirror 11 to the light modulator 4G.

The light modulator 4R is disposed in the optical path of the red light RL reflected off the first total reflection mirror 13 and output from the first total reflection mirror 13. The light modulator 4R modulates the red light RL incident thereon in accordance with image information input from an image input apparatus that is not shown to form red image light and outputs the red image light. The light modulator 4G is disposed in the optical path of the green light GL reflected off the second dichroic mirror 12 and output from the second dichroic mirror 12. The light modulator 4G modulates the green light GL incident thereon in accordance with image information input from the image input apparatus, which is not shown, to form green image light and outputs the green image light. The light modulator 4B is disposed in the optical path of the blue light BL reflected off the third total reflection mirror 15 and output from the third total reflection mirror 15. The light modulator 4B modulates the blue light BL incident thereon in accordance with image information input from the image input apparatus, which is not shown, to form blue image light and outputs the blue image light. The image input apparatus is, for example, a personal computer or a portable terminal device.

The light modulators 4R, 4G, and 4B are each, for example, a transmissive liquid crystal panel. Polarizers that are not shown are disposed at the light incident and exiting sides of each of the liquid crystal panels. A field lens 10R is disposed in the optical path of the red light RL between the first total 1 reflection mirror 13 and the light modulator 4R. A field lens 10G is disposed in the optical path of the green light GL between the second dichroic mirror 12 and the light modulator 4G. A field lens 10B is disposed in the optical path of the blue light BL between the third total reflection mirror 15 and the light modulator 4B.

The light combining system 5 is disposed so as to lie on the optical path of the red image light output from the light modulator 4R, the optical path of the green image light output from the light modulator 4G, and the optical path of the blue image light output from the light modulator 4B. In the plan view or the side view as shown in FIG. 1, the position where the light combining system 5 combines the three types of color light with each other coincides with the intersection of the optical path of the red image light, the optical path of the green image light, and the optical path of the blue image light. The light combining system 5 combines the red image light, the green image light, and the blue image light with each other to form color image light. The light combining system 5 outputs the color image light. The light combining system 5 is, for example, a cross dichroic prism.

The projection system 6 is disposed in the optical path of the color image light output from the light combining system 5. The color image light output from the light combining system 5 corresponds to the light modulated by the light modulators 4R, 4G, and 4B. The projection system 6 enlarges the color image light output from the light combining system 5 and entering the projection system 6, and projects the enlarged color image light toward the screen SCR. The color image light enlarged and projected by the projection system 6 is displayed as color video images on a display surface of the screen SCR that faces a light exiting surface of the projection system 6.

The projection system 6 is formed, for example, of a plurality of optical lenses, and may instead be formed of a single optical lens. Examples of the optical lenses may include a variety of lenses, such as a plano-convex lens, a biconvex lens, a meniscus lens, an aspherical lens, a rod lens, and a freeform surface lens.

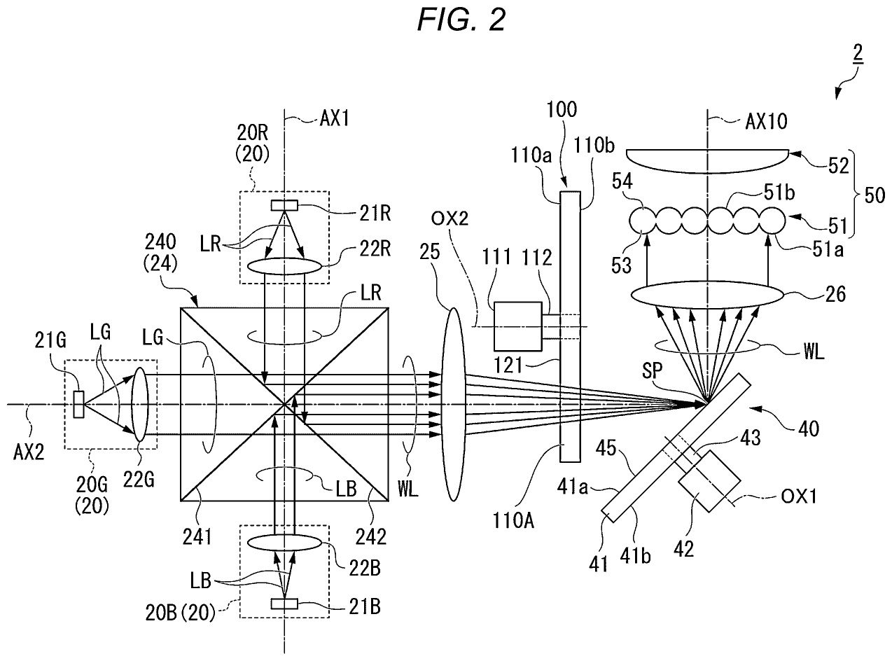

An illuminator according to the embodiment of the present disclosure will subsequently be described with reference to FIGS. 2 to 4. FIG. 2 is a schematic view showing the configuration of the illuminator 2 according to the embodiment of the present disclosure. The illuminator 2 includes a first light source 20R, a second light source 20G, a third light source 20B, a light combining member 24, a light collector 25, a first diffuser 40, a second diffuser 100, a collimator 26, and an optical integration system 50.

The first light source 20R includes a first laser device 21R and a first collimation lens 22R, and outputs the red light LR. The first laser device 21R emits the red light LR. The red light LR has a wavelength band having wavelengths that belong to red in the visible wavelength band, for example, a wavelength band ranging from 585 nm to 720 nm. The red light LR is emitted from the first laser device 21R conically around an optical axis AX1. The red light LR corresponds to first light. The wavelengths that form the red light LR and belong to red correspond to a first wavelength.

The first collimation lens 22R is disposed in the optical path of the red light LR emitted from the first laser device 21R and in the optical axis AX1. The center of the first collimation lens 22R in the direction perpendicular to the optical axis AX1 substantially coincides with the optical axis AX1. The first collimation lens 22R parallelizes the red light LR incident thereon. The second light source 20G includes a second laser device 21G and a second collimation lens 22G, and outputs the green light LG. The second laser device 21G emits the green light LG. The green light LG has a wavelength band having wavelengths that belong to green in the visible wavelength band, for example, a wavelength band ranging from 495 nm to 585 nm. The green light LG corresponds to second light. The wavelengths that form the green light LG and belong to green correspond to a second wavelength.

The green light LG is emitted from the second laser device 21G conically around an optical axis AX2. In the plan view or the side view as shown in FIG. 2, the optical axis AX2 from the second laser device 21G to the position where the light combining member 24, which will be described later, combines the three types of color light with each other is perpendicular to the optical axis AX1 from the first laser device 21R to the position where the light combining member 24 combines the three types of color light with each other.

The second collimation lens 22G is disposed in the optical path of the green light LG emitted from the second laser device 21G and in the optical axis AX2. The center of the second collimation lens 22G in the direction perpendicular to the optical axis AX2 substantially coincides with the optical axis AX2. The second collimation lens 22G parallelizes the green light LG incident thereon.

The third light source 20B includes a third laser device 21B and a third collimation lens 22B, and outputs the blue light LB. The third laser device 21B emits the blue light LB. The blue light LB has a wavelength band having wavelengths that belong to blue in the visible wavelength band, for example, a wavelength band ranging from 380 nm to 495 nm. The blue light LB is emitted from the third laser device 21B conically around the optical axis AX1. The optical axis AX1 of the blue light LB and the optical axis AX1 of the red light LR form the same line, and the optical axis AX1 of the blue light LB is the extension of the optical axis AX1 of the red light LR extended toward the light combining member 24 so as to pass through the position where the light combining member 24 combines the three types of color light with each other, and further extended toward the side opposite from the first light source 20R with respect to the light combining member 24. The blue light LB is output to the light combining member 24 in the direction parallel to the direction in which the red light LR is output but in the opposite direction thereof.

In FIG. 2, the first light source 20R, the second light source 20G, and the third light source 20B each include one laser light source and one collimation lens, but the number of light sources and collimation lenses in each of the light sources is not limited to a specific number, and the relative arrangement of the light sources is not limited to a specific arrangement. For example, the first light source 20R, the second light source 20G, and the third light source 20B may each include two or more laser light sources and the same number of collimation lenses as the laser light sources. The first light source 20R, the second light source 20G, and the third light source 20B may each include a member other than the laser light source and the collimation lens, such as a package that holds the laser light source and the collimation lens.

The light combining member 24 is disposed so as to lie on the optical path of the red light LR output from the first light source 20R, the optical path of the green light LG output from the second light source 20G, and the optical path of the blue light LB output from the third light source 20B. In the plan view or the side view as shown in FIG. 2, the position where the light combining member 24 combines the three types of color light with each other coincides with the intersection of the optical path of the red light LR, the optical path of the green light LG, and the optical path of the blue light LB, that is, the intersection of the optical axis AX1 and the optical axis AX2.

The light combining member 24 combines the red light LR, the green light LG, and the blue light LB incident thereon with each other to generate the white light WL. The white light WL corresponds to combined light. The light combining member 24 outputs the white light WL along the optical axis AX2. The optical axis AX2 of the white light WL and the optical axis AX2 of the green light LG form the same line. The optical axis AX2 of the white light WL is an extension of the optical axis AX2 of the green light LG extended toward the light combining member 24 so as to pass through the position where the light combining member 24 combines the three types of color light with each other, and further extended toward the side opposite from the second light source 20G with respect to the light combining member 24.

The light combining member 24 is, for example, a cross dichroic prism 240. The cross dichroic prism 240 includes a first dichroic mirror 241 and a second dichroic mirror 242. In the plan view or the side view in which the optical axes AX1 and AX2 are perpendicular to each other, the reflection surface of the first dichroic mirror 241 and the reflection surface of the second dichroic mirror 242 each incline with respect to the optical axes AX1 and AX2. In the plan view or the side view, the angle between the reflection surface of each of the first dichroic mirror 241 and the second dichroic mirror 242 and each of the optical axes AX1 and AX2 is 45°. In the plan view or the side view in which the optical axes AX1 and AX2 are perpendicular to each other, the reflection surface of the first dichroic mirror 241 and the reflection surface of the second dichroic mirror 242 are perpendicular to each other.

The first dichroic mirror 241 reflects the blue light LB and transmits the green light LG and the red light LR. The second dichroic mirror 242 reflects the red light LR and transmits the blue light LB and the green light LG. The red light LR output from the first light source 20R is incident on the second dichroic mirror 242 along the optical axis AX1, is reflected off the second dichroic mirror 242, is output along the optical axis AX2 toward the side opposite from the second light source 20G, and passes through the first dichroic mirror 241. The green light LG output from the second light source 20G is incident on the first dichroic mirror 241 along the optical axis AX2, travels straight, and passes through the first dichroic mirror 241 and the second dichroic mirror 242. The blue light LB output from the third light source 20B is incident on the first dichroic mirror 241 along the optical axis AX1, is reflected off the first dichroic mirror 241, is output along the optical axis AX2 toward the side opposite from the second light source 20G, and passes through the second dichroic mirror 242.

The red light LR, the green light LG, and the blue light LB output from the first dichroic mirror 241 and the second dichroic mirror 242 are combined with each other to generate the white light WL, as described above. The white light WL is output along the optical axis AX2 via the side surface of the cross dichroic prism 240 that is opposite from the side surface facing the second light source 20G.

The light collector 25 is disposed in the optical path of the white light WL between the light combining member 24 and the first diffuser 40. The light collector 25 collects the collimated white light WL output from the light combining member 24 and outputs the collected white light WL toward the first diffuser 40. The center of the light collector 25 in the direction perpendicular to the optical axis AX2 substantially coincides with the optical axis AX2. The light collector 25 is, for example, a biconvex lens, and may instead be an optical element having a light collecting function other than a biconvex lens, or a plano-convex lens, or may still instead be formed of a plurality of optical lenses.

The first diffuser 40 is disposed in the optical path of the white light WL output from the light collector 25. The first diffuser 40 diffuses the white light WL collected by the light collector 25 and incident on the first diffuser 40, and outputs the diffused white light WL. The first diffuser 40 is, for example, a reflective diffuser, and diffusively reflects the white light WL incident thereon.

The first diffuser 40 includes, for example, a substrate 41 and a driver 42. The substrate 41 corresponds to a first substrate. The driver 42 corresponds to a first driver. The substrate 41 has a light incident surface 41a, which is irradiated with the white light WL collected by the light collector 25 and at which a collected light spot SP of the white light WL is therefore formed, and a rear surface 41b opposite from the light incident surface 41a. The substrate 41 is disposed with the light incident surface 41a facing the light collector 25. In the plan view or the side view in which the optical axes AX1 and AX2 are perpendicular to each other, the angle between the light incident surface 41a and the optical axis AX2 is 45°.

The substrate 41 is attached to the driver 42 so as to be rotatable around an axis of rotation OX1. The driver 42 rotates the substrate 41 around the axis of rotation OX1. The driver 42 is, for example, a motor, and includes a shaft member 43 having a center axis that coincides with the axis of rotation OX1. For example, the shaft member 43 is inserted into a central portion of the substrate 41 from the side facing the rear surface 41b. The centers of the light incident surface 41a and the rear surface 41b of the substrate 41 coincide with the axis of rotation OX1. The substrate 41 rotates around the axis of rotation OX1 as described above in conjunction with the rotation of the shaft member 43 around the axis of rotation OX1, and diffuses the white light WL. The driver 42 is not limited to a motor and only needs to be an apparatus capable of rotating the substrate 41 as described above.

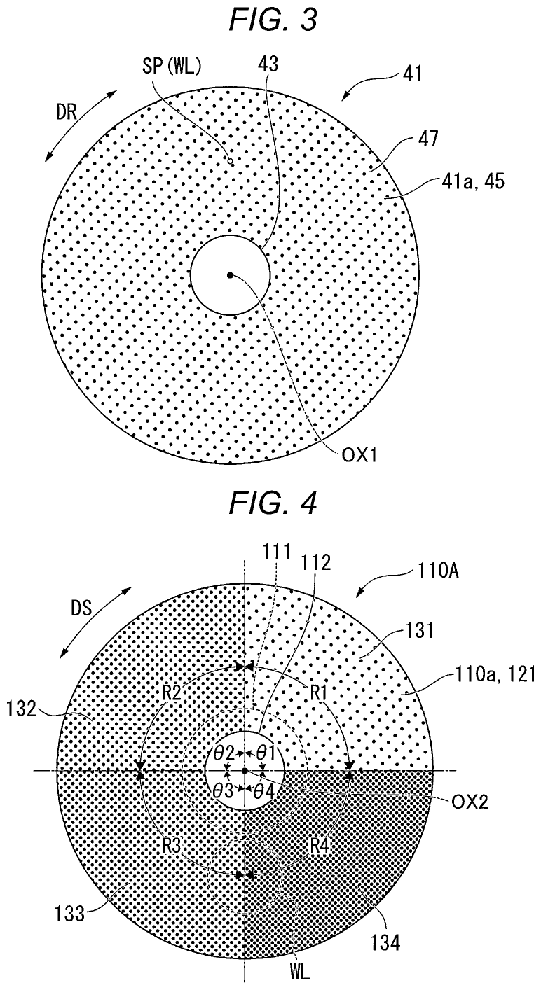

FIG. 3 is a schematic diagram of the substrate 41 of the first diffuser 40 viewed from the side facing the light incident surface 41a along the axis of rotation OX1. When viewed along the axis of rotation OX1, the collected light spot SP of the white light WL is formed at the light incident surface 41a of the substrate 41 in a region between the radial center of the light incident surface 41a, that is, the axis of rotation OX1, and the circumferential end thereof, as shown in FIGS. 2 and 3. The light incident surface 41a constitutes a diffusion surface 45, which diffuses the white light WL incident thereon and outputs the diffused white light WL. The diffusion surface 45 corresponds to a first diffusion surface. A protruding and recessed structure 47 is formed at the light incident surface 41a. The protruding and recessed structure 47 is designed as appropriate in consideration of the wavelength band of the white light WL so as to appropriately diffuse the white light WL, and is formed the same as a protruding and recessed structure formed at a known diffusion plate. The protruding and recessed structure 47 may be formed, for example, by blasting, or may be realized by forming a plurality of microlenses each having a diameter smaller than or equal to the wavelengths of the white light WL by using the optical lithography technology. The protruding and recessed structure 47 may be formed, for example, by dispersing a plurality of particles each having an appropriate particle diameter on the base of the substrate 41 and covering the plurality of particles with resin in such a way that the resin reflects the shape of the surface formed by the plurality of particles. The protruding and recessed structure 47 may be formed across the entire range in the radial direction from the center of the light incident surface 41a to the circumferential end thereof as shown in FIG. 3, or may instead be formed in a smaller range in the radial direction including at least the region irradiated with the collected light spot SP.

When the substrate 41 is made of a material that transmits the white light WL, such as optical glass and plastic, a reflection film that is not shown is, for example, provided at the surface of the protruding and recessed structure 47. When the substrate 41 is made of a material that reflects the white light WL, such as metal, a reflection film that is not shown may not be provided at the surface of the protruding and recessed structure 47. Providing a reflection film, however, improves the reflection characteristics of the light incident surface 41a. In FIG. 3, the protruding and recessed structure 47 is shown by dots by way of example. The protruding and recessed structure 47 is made of a material that does not block but transmits the white light WL, as the substrate 41 is.

When the substrate 41 of the first diffuser 40 rotates in a rotational direction DR around the axis of rotation OX1, the speckle pattern of the white light WL in the collected light spot SP changes. The white light WL is diffusively reflected off the diffusion surface 45, and output from the collected light spot SP along an optical axis AX10 as diffused light having a diffusion, scattering, or diffraction pattern produced by the protruding and recessed structure 47. The optical axis AX10 passes through the center of a region of the light incident surface 41a of the substrate 41 that is the region irradiated with the collected light spot SP, and is parallel to the optical axis AX1.

Referring back to FIG. 2, the second diffuser 100 is disposed in the optical path of the white light WL between the light collector 25 and the first diffuser 40. The second diffuser 100 diffuses, at a position upstream from the first diffuser 40 in the traveling direction of the white light WL, the white light WL collected by the light collector 25 and incident on the second diffuser 100, and outputs the diffused white light WL toward the first diffuser 40. The second diffuser 100 is a transmissive diffuser, and diffusively transmits the white light WL incident on.

The second diffuser 100 includes, for example, a substrate 110A and a driver 111. The substrate 110A corresponds to a second substrate. The driver 111 corresponds to a second driver. The substrate 110A has a light incident surface 110a, which is irradiated with the white light WL being collected by the light collector 25, and a light exiting surface 110b opposite from the light incident surface 110a. The substrate 110A is disposed with the light incident surface 110a facing the light collector 25. The light incident surface 110a is perpendicular to the optical axis AX2.

The substrate 110A is attached to the driver 111 so as to be rotatable around an axis of rotation OX2. The driver 111 rotates the substrate 110A around the axis of rotation OX2. The driver 111 is, for example, a motor, and includes a shaft member 112 having a center axis that coincides with the axis of rotation OX2. For example, the shaft member 112 is inserted into a central portion of the substrate 110A from the side facing the light incident surface 110a. The centers of the light incident surface 110a and the light exiting surface 110b of the substrate 110A coincide with the axis of rotation OX2. The substrate 110A rotates around the axis of rotation OX2 as described above in conjunction with the rotation of the shaft member 112 around the axis of rotation OX2, diffuses the white light WL, and changes the intensity distribution and the phase distribution in the collected light spot SP of the white light WL radiated to the light incident surface 41a of the substrate 41 of the first diffuser 40, and the diameter of the collected light spot SP. That is, the second diffuser 100 temporally changes the state of the collected light spot SP of the white light WL at the diffusion surface 45 of the first diffuser 40. The driver 111 is not limited to a motor and only needs to be an apparatus capable of rotating the substrate 110A as described above.

FIG. 4 is a schematic view of the substrate 110A of the second diffuser 100 viewed from the side facing the light incident surface 110a along the axis of rotation OX2. When viewed along the axis of rotation OX2, the region of the substrate 110A that is irradiated with the white light WL is a part of the region of the light incident surface 110a of the substrate 110A that does not overlap with the driver 111 and is located between the radial center of the light incident surface 110a, that is, the axis of rotation OX2, and the circumferential end of the light incident surface 110a, as shown in FIGS. 2 and 4.

The light incident surface 110a constitutes a diffusion surface 121, which diffuses the white light WL incident thereon and outputs the diffused white light WL. The diffusion surface 121 corresponds to a second diffusion surface. The substrate 110A rotates around the axis of rotation OX2 in a rotational direction DS, that is, in the circumferential direction. The light incident surface 110a and the diffusion surface 121 include, for example, a first region R1, a second region R2, a third region R3, and a fourth region R4. The light incident surface 110a and the diffusion surface 121 are segmented into the first region R1, the second region R2, the third region R3, and the fourth region R4 in the rotational direction DS. Angles θ1, θ2, θ3, and θ4 of the first region R1, the second region R2, the third region R3, and the fourth region R4 in the rotational direction DS are each 90°.

A protruding and recessed structure 131 is formed in the first region R1 of the diffusion surface 121. The protruding and recessed structure 131 is designed as appropriate in consideration of the wavelength band of the white light WL so as to appropriately diffuse the white light WL, and is formed the same as a protruding and recessed structure formed at a known diffusion plate. The state in which the white light WL is appropriately diffused means a state in which the white light WL diffused by the diffusion surface 121 of the second diffuser 100 is further diffused by the diffusion surface 45 of the first diffuser 40, output from the diffusion surface 45, and then modulated into image light by the light modulators 4R, 4G, and 4B of the projector 1, so that speckle noise produced when the image light is projected onto the screen SCR is satisfactorily reduced, as will be described later. The protruding and recessed structure 131 corresponds to a first protruding and recessed structure.

The protruding and recessed structure 131 may be formed, for example, by blasting or etching, or may be formed in a random pattern in which protrusions and recesses are arranged irregularly. The protruding and recessed structure 131 may be realized by forming a plurality of microlenses each having a diameter smaller than or equal to the wavelengths of the white light WL by using the optical lithography technology. The protruding and recessed structure 131 may be formed, for example, by dispersing a plurality of particles each having an appropriate particle diameter on the base of the substrate 110A and covering the plurality of particles with resin in such a way that the resin reflects the shape of the surface formed by the plurality of particles.

A protruding and recessed structure 132 is formed in the second region R2 of the diffusion surface 121. The protruding and recessed structure 132 has at least a diffusion characteristic different from that of the protruding and recessed structure 131, and has a shape different from that of the protruding and recessed structure 131. The protruding and recessed structure 132 corresponds to a second protruding and recessed structure. Specifically, the protruding and recessed structure 132 may be created by a method different from the method by which the protruding and recessed structure 131 is created. The protruding and recessed structure 132 may instead be created by the same method by which the protruding and recessed structure 131 is created, and may have, for example, a distribution of the height of the protrusions and the depth of the recesses and the interval between the protrusions and the recesses different from the distribution of those of the protruding and recessed structure 131. When the protruding and recessed structure 131 has a uniform protruding and recessed pattern, the protruding and recessed structure 132 may have a non-uniform protruding and recessed pattern. Conversely, when the protruding and recessed structure 131 has a non-uniform protruding and recessed pattern, the protruding and recessed structure 132 may have a uniform protruding and recessed pattern, or the protruding and recessed structure 132 may also have a non-uniform protruding and recessed pattern but may have non-uniformity different from that of the protruding and recessed structure 131.

A protruding d structure 133 is formed in the third region R3 of the diffusion surface 121. The protruding and recessed structure 133 has a diffusion characteristic different from that of each of the protruding and recessed structures 131 and 132, and has a shape different from that of each of the protruding and recessed structures 131 and 132. Specifically, the protruding and recessed structure 133 may be created by a method different from the methods by which the protruding and recessed structures 131 and 132 are created. The protruding and recessed structure 133 may be created by the same method by which any of the protruding and recessed structures 131 and 132 is created, and may have, for example, a distribution of the height of the protrusions and the depth of the recesses and the interval between the protrusions and the recesses different from the distribution of those of each of the protruding and recessed structures 131 and 132. When the protruding and recessed structure 132 has a uniform protruding and recessed pattern, the protruding and recessed structure 133 may have a non-uniform protruding and recessed pattern. Conversely, when the protruding and recessed structure 132 has a non-uniform protruding and recessed pattern, the protruding and recessed structure 133 may have a uniform protruding and recessed pattern, or the protruding and recessed structure 133 may also have a non-uniform protruding and recessed pattern but may have non-uniformity different from that of each of the protruding and recessed structures 131 and 132.

A protruding and recessed structure 134 is formed in the fourth region R4 of the diffusion surface 121. The protruding and recessed structure 134 has a diffusion characteristic different from that of each of the protruding and recessed structures 131, 132 and 133, and has a shape different from that of each of the protruding and recessed structures 131, 132 and 133. Specifically, the protruding and recessed structure 134 may be created by a method different from the methods by which the protruding and recessed structures 131, 132 and 133 are created. The protruding and recessed structure 134 may be created by the same method by which any of the protruding and recessed structures 131, 132 and 133 is created, and may have, for example, a distribution of the height of the protrusions and the depth of the recesses and the interval between the protrusions and the recesses different from the distribution of those of each of the protruding and recessed structures 131, 132 and 133. When the protruding and recessed structures 131 and 133 each have a uniform protruding and recessed pattern, the protruding and recessed structure 134 may have a non-uniform protruding and recessed pattern. Conversely, when the protruding and recessed structures 131 and 133 each have a non-uniform protruding and recessed pattern, the protruding and recessed structure 134 may have a uniform protruding and recessed pattern, or the protruding and recessed structure 134 may also have a non-uniform protruding and recessed pattern but may have non-uniformity different from that of each of the protruding and recessed structures 131, 132 and 133.

The protruding and recessed structures 131, 132, 133, and 134 may each be formed across the entire range in the radial direction from the center of the light incident surface 110a to the circumferential end thereof as shown in FIG. 4, or may instead be formed in a smaller range in the radial direction including at least the region irradiated with the white light WL.

The substrate 110A is made of a material that transmits the white light WL, such as optical glass and plastic. In FIG. 4, the configuration in which protruding and recessed structures 131, 132, 133, and 134 have diffusion characteristics different from each other is expressed by differences in dot density. The protruding and recessed structures 131, 132, 133, and 134 are each made of a material that does not block but transmits the white light WL, as the substrate 110A is.

When the substrate 110A of the second diffuser 100 rotates in the rotational direction DS around the axis of rotation OX2, the amplitude distribution and the phase distribution of the white light WL output from the light collector 25 are modulated in accordance with the protruding and recessed structures 131, 132, 133, and 134, so that the speckle pattern of the white light WL changes. Whenever the substrate 110A makes one revolution in the rotational direction DS, four kinds of speckle patterns of the white light WL according to the protruding and recessed structures 131, 132, 133, and 134 are produced. The white light WL is diffused at the diffusion surface 121, has a diffusion, scattering, or diffraction pattern produced by the protruding and recessed structures 131, 132, 133, and 134, and passes as diffused light through the substrate 110A, and exits via the light exiting surface 110b along the optical axis AX2.

The rotation speed at which the substrate 110A of the second diffuser 100 rotates in the rotational direction DS around the axis of rotation OX2 is, for example, 1/240 [revolutions/second] or faster. That is, the rotation speed produced by the driver 111 around the axis of rotation OX2 is set at 1/240 [revolutions/second] or faster. The first region R1, the second region R2, the third region R3, and the fourth region R4 irradiated, for example, with the white light WL is therefore switched from one to another in a short period of 1/60 seconds or shorter. The diffusion, scattering, or diffraction pattern and the speckle pattern of the collected light spot SP of the white light WL incident on the diffusion surface 45 of the substrate 41 of the first diffuser 40 change in the short period of 1/60 seconds or shorter. The state of the collected light spot SP at the diffusion surface 45 of the first diffuser 40 therefore changes at a frequency higher than or equal to 60 [Hz] as the substrate 110A rotates. That is, the diffusion, scattering, or diffraction pattern and the speckle pattern of the collected light spot SP of the white light WL incident on the diffusion surface 45 are switched at the frequency higher than or equal to 60 [Hz].

Referring back to FIG. 2, the substrate 41 of the first diffuser 40 is irradiated with the collected light spot SP of the diffused white light WL output via the light exiting surface 110b of the substrate 110A of the second diffuser 100 with the state of the diffused white light WL temporally switched. The speckle pattern of the white light WL reflected off the light incident surface 41a of the substrate 41 of the first diffuser 40 and output along the optical axis AX10 therefore shows a synergistic effect between any one of the four types of protruding and recessed structures 131, 132, 133, and 134 and the protruding and recessed structure 47. The speckle pattern of the white light WL output along the optical axis AX10 is determined by the optical overlap of the diffusion, scattering, or diffraction pattern produced by any one of the protruding and recessed structures 131, 132, 133, and 134 with the diffusion, scattering, or diffraction pattern produced by the protruding and recessed structure 47, and the thus determined speckle pattern changes with time.

The collimator 26 is disposed in the optical path of the white light WL output from the substrate 41 of the first diffuser 40. The collimator 26 parallelizes the diffusively diverging white light WL output from the light incident surface 41a and the diffusion surface 45 of the substrate 41. The center of the collimator 26 in the direction perpendicular to the optical axis AX10 substantially coincides with the optical axis AX10. The collimator 26 is, for example, a biconvex lens, and may instead be an optical element having a light collecting function other than a biconvex lens, or a plano-convex lens, or may still instead be formed of a plurality of optical lenses. When the collimator 26 is formed by a single optical lens, using an aspherical lens allows further improvement in the accuracy of the collimation.

The optical integration system 50 includes a multi-lens array 51 and a superimposing lens 52. The optical integration system 50 homogenizes the illuminance distribution of the white light WL output from the collimator 26 in an image formation region of each of the light modulators 4R, 4G, and 4B disposed downstream from the optical integration system 50.

The multi-lens array 51 is disposed in the optical path of the parallelized white light WL output from the collimator 26. The multi-lens array 51 is, for example, a double-sided multi-lens array or includes multi-lens arrays at opposite sides. The double-sided multi-lens array includes a plurality of microlenses 53, which divide the white light WL output from the collimator 26 into a plurality of thin luminous fluxes. The plurality of microlenses 53 are adjacent to each other along a plane perpendicular to the optical axis AX10 and are arranged in a matrix. The microlenses 53 are each, for example, a plano-convex lens having a convex surface at the light incident side. The double-sided multi-lens array has a first multi-lens surface 51a provided at the light incident side along the shape of the plano-convex lenses, which constitute the microlenses 53. The double-sided multi-lens array further includes a plurality of microlenses 54, the number of which is equal to the number of plurality of microlenses 53, in a plane perpendicular to the optical axis AX10. The microlenses 54 are adjacent to each other along a plane perpendicular to the optical axis AX10, are arranged in a matrix, and correspond to the microlenses 53. The microlenses 54 are each, for example, a plano-convex lens having a convex surface at the light exiting side. The light-exiting-side surface of each of the plurality of microlenses 54 is the same as the light-incident-side surface of the corresponding one of the plurality of microlenses 53. The double-sided multi-lens array has a second multi-lens surface 51b provided at the light exiting side along the shape of the plano-convex lenses, which constitute the microlenses 54.

The superimposing lens 52 collects each of the plurality of thin luminous fluxes of the white light WL output from the multi-lens array 51, and cooperates with the plurality of microlenses 54 of the multi-lens array 51 to superimpose the thin luminous fluxes with each other in the image formation region of each of the light modulators 4R, 4G, and 4B or in the vicinity of the image formation region. The superimposing lens 52 is, for example, a plano-convex lens, and may instead be an optical element having a light collecting function other than a plano-convex lens, or a biconvex lens, or may still instead be formed of a plurality of optical lenses.

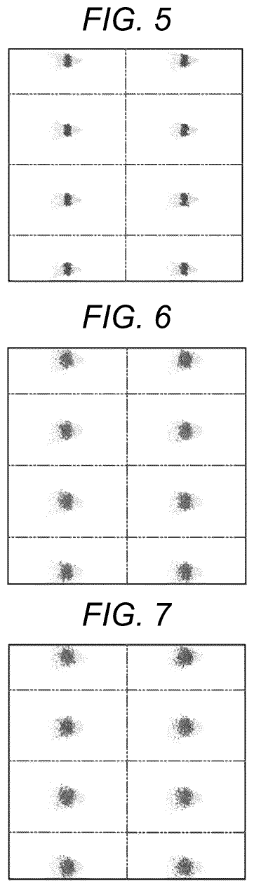

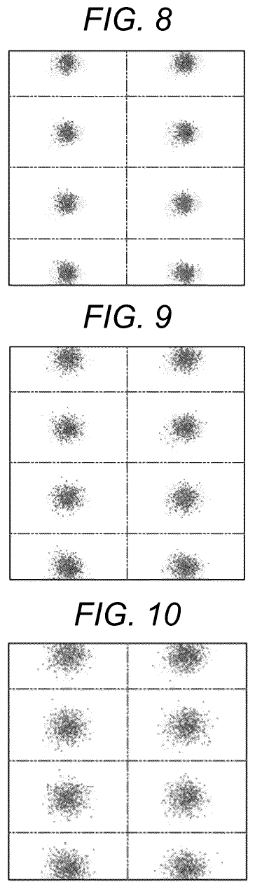

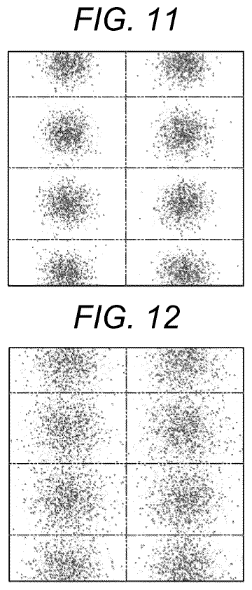

Numerical calculation examples in which the beam distribution at the light incident surfaces of the plurality of microlenses 54 of the multi-lens array 51 in the illuminator 2 according to the present embodiment are calculated in the form of a simulation will be subsequently described with reference to FIGS. 5 to 12.

FIGS. 5 to 12 are each a diagram in which the white light WL incident on the plurality of microlenses 54 of the multi-lens array 51 is treated as beams the number of which is common to FIGS. 5 to 12, and the locations where the beams intersect with the light incident surfaces of the plurality of microlenses 54 are indicated by points, and are each therefore a diagram showing the distribution of the beams. The two-dot chain lines in each of FIGS. 5 to 12 represent the boundary of the light incident surface of each of the plurality of microlenses 54.

In the following description on the present simulation, cosⁿ θ, n being the exponent, represents the state of the white light WL diffused by one of the protruding and recessed structures 131, 132, 133, and 134 formed at the light incident surface 110a and the diffusion surface 121 of the substrate 110A of the second diffuser 100, for example, the protruding and recessed structure 131. Cosⁿ θ is a known diffusion approximation's coefficient indicating the state of light diffused by a diffusive optical material or optical member to quantitatively represent the diffusion characteristic of the optical material or the optical member. The symbol n is a natural number. A relatively large exponent n means a relatively small diffusion power, for example, means that the protruding and recessed structure formed at the diffusion surface 121 includes protrusions and the recesses arranged at relatively large intervals, or intervals close to a reference wavelength of the incident white light WL.

In the present simulation, the temporal change of the protruding and recessed structure that occurs when the substrate 110A rotates, that is, the difference in the exponent n in cosⁿ θ for the four types of protruding and recessed structures 131, 132, 133, and 134 is not taken into consideration.

### Numerical Calculation Example 1

FIG. 5 shows the result of calculation of the beam distribution at the light incident surface of the plurality of microlenses 54 of the multi-lens array 51 in the configuration in which the second diffuser 100 of the illuminator 2 according to the present embodiment is not provided, that is, in an illuminator of related art in Numerical Calculation Example 1 of the present simulation. In the illuminator of related art that does not include the second diffuser 100, the beams of the white light WL concentrate at a central portion of the light incident surface of each of the plurality of microlenses 54 of the multi-lens array 51, as shown in FIG. 5. In Numerical Calculation Example 1, the high density region at which the beams of the white light WL concentrate more densely than the peripheral region has a predetermined width, with the beams not concentrating at one point in the central portion of the light incident surface of each of the plurality of microlenses 54. The high density region results in the fact that the first light source 20R, the second light source 20G, and the third light source 20B each have a certain size. The light emission surface of each of the first light source 20R, the second light source 20G, and the third light source 20B each form a spot image at the light incident surface 41a of the substrate 41 of the first diffuser 40. The spot images are formed at the light incident surfaces of the plurality of microlenses 54, which are conjugate with the light incident surface 41a.

### Numerical Calculation Example 2

FIG. 6 shows the result of calculation of the beam distribution at the light incident surface of each of the plurality of microlenses 54 of the multi-lens array 51 in Numerical Calculation Example 2 of the present simulation performed when the state of the white light WL diffused by the protruding and recessed structure 131 formed at the diffusion surface 121 of the substrate 110A of the second diffuser 100 is specified by the exponent n=100000 in the configuration of the illuminator 2 according to the present embodiment. In the illuminator 2 according to the present embodiment and Numerical Calculation Example 2, the white light WL is diffused, for example, by the protruding and recessed structure 131 formed at the light incident surface 110a and the diffusion surface 121 of the substrate 110A of the second diffuser 100, as shown in FIG. 6. Therefore, in the high density region, at which the beams of the white light WL concentrate more densely than in the peripheral region, the beams do not concentrate at one point in the central portion of the light incident surface of each of the plurality of microlenses 54. The high density region in Numerical Calculation Example 2 is wider than the high density region in Numerical Calculation Example 1. The width of the high density region in Numerical Calculation Example 2 depends on the diffusion characteristic of the protruding and recessed structure 131, the diffusion state of the white light WL diffused by the protruding and recessed structure 131, and the exponent n. From the result of Numerical Calculation Example 2, it is also quantitatively ascertained that the white light WL incident on the multi-lens array 51 is diffused in the light incident surface of each of the plurality of microlenses 54 by a greater degree in the illuminator 2 according to the present embodiment than in the illuminator of related art.

### Numerical Calculation Examples 3 to 7

FIGS. 7 to 11 show the results of calculation of the beam distribution at the light incident surface of each of the plurality of microlenses 54 of the multi-lens array 51 in Numerical Calculation Examples 3 to 7 of the present simulation performed when the state of the white light WL diffused by the protruding and recessed structure 131 formed at the diffusion surface 121 of the substrate 110A of the second diffuser 100 in the configuration of the illuminator 2 according to the present embodiment is specified by the exponent n=50000 in Numerical Calculation Example 3, the exponent n=25000 in Numerical Calculation Example 4, the exponent n=10000 in Numerical Calculation Example 5, the exponent n=5000 in Numerical Calculation Example 6, and the exponent n=2500 in Numerical Calculation Example 7. In the illuminator 2 according to the present embodiment and Numerical Calculation Examples 3 to 7, the white light WL is diffused, for example, by the protruding and recessed structure 131 as shown in FIGS. 7 to 11, as in Numerical Calculation Example 2. In Numerical Calculation Examples 3 to 7, the width of the high density region, at which the beams of the white light WL at the light incident surface of each of the plurality of microlenses 54 concentrate more densely than in the peripheral portion, increases as the exponent n decreases, so that the peak of the density distribution of the white light WL decreases. From the results of Numerical Calculation Examples 3 to 7, it is quantitatively ascertained that, in the illuminator 2 according to the present embodiment, the white light WL incident on the multi-lens array 51 is diffused in the light incident surface of each of the plurality of microlenses 54 by a greater degree than in the illuminator of related art, so that the beam width of the white light WL increases as the exponent n decreases, and the peak intensity of the white light WL decreases. In the illuminator 2 according to the present embodiment, the white light WL incident on the multi-lens array 51 of the optical integration system 50 is favorably diffused by any one of the protruding and recessed structures 131, 132, 133, and 134 of the diffusion surface 121 of the substrate 110A of the second diffuser 100 before diffused by the protruding and recessed structure 47 of the diffusion surface 45 of the substrate 41 of the first diffuser 40. When the exponent n is, for example, greater than or equal to 2500, the collected white light WL falls within each of the plurality of microlenses 54, and a decrease in the efficiency at which the white light WL is used is suppressed. In addition, the polarization characteristics of the red light RL incident on the light modulator 4R, the green light GL incident on the light modulator 4G, and the blue light BL incident on the light modulator 4B are likely to be disturbed.

### Numerical Calculation Example 8

FIG. 12 shows the result of calculation of the beam distribution at the light incident surface of each of the plurality of microlenses 54 of the multi-lens array 51 in Numerical Calculation Example 8 of the present simulation performed when the state of the white light WL diffused by the protruding and recessed structure 131 formed at the diffusion surface 121 of the substrate 110A of the second diffuser 100 is specified by the exponent n=1000 in the configuration of the illuminator 2 according to the present embodiment. In the illuminator 2 according to the present embodiment and Numerical Calculation Example 8, the white light WL is diffused, for example, by the protruding and recessed structure 131 as shown in FIG. 12, as in each of Numerical Calculation Examples 2 to 7. In the Numerical Calculation Example 8, however, the white light WL incident on the multi-lens array 51 does entirely not fall within the light incident surface of each of the plurality of microlenses 54, but is diffused into the light incident surfaces adjacent to the light incident surface of the microlens 54. This indicates that when the exponent n of the state of the white light WL diffused by the protruding and recessed structure 131 decreases to 1000, the light incident on each of the plurality of microlenses 54 of the multi-lens array 51 is also incident on the adjacent microlenses 54. In this case, in the projector 1 according to the present embodiment, the efficiency at which the white light WL output from the illuminator 2 is used decreases in accordance with the amount of white light WL extended beyond each of the plurality of microlenses 54. In addition, the polarization characteristics of the red light RL incident on the light modulator 4R, the green light GL incident on the light modulator 4G, and the blue light BL incident on the light modulator 4B are likely to be disturbed.

### Summary of Numerical Calculation Examples

From the results of Numerical Calculation Examples 1 to 8 of the present simulation, the state of the white light WL diffused by the protruding and recessed structures 131, 132, 133, and 134 formed at the diffusion surface 121 of the substrate 110A of the second diffuser 100 is designed to be a non-diffusion state in which the white light WL is not diffused at the light incident surface 110a of the substrate 110A, for example, at a flat surface at which no protrusions or recesses are formed, or a diffusion state in which the thin luminous fluxes of the white light WL incident on the light incident surface of each of the microlenses 54 are not incident on the light incident surfaces of the microlenses 54 adjacent to the microlens 54 at least in the multi-lens array 51. The state of the white light WL diffused by the protruding and recessed structures 131, 132, 133, and 134 is preferably, for example, diffusion states achieved by the exponent n greater than 1000, and is more preferably diffusion states achieved by the exponent n greater than or equal to 2500 but smaller than or equal to 100000.

The illuminator 2 according to the present embodiment described above includes at least the first light source 20R and the second light source 20G, and further includes the third light source 20B. The illuminator 2 according to the present embodiment includes the light combining member 24, the first diffuser 40, the light collector 25, the collimator 26, and the second diffuser 100. The first light source 20R outputs the red light (first light) LR having the first wavelength. The second light source 20G outputs the green light (second light) LG having the second wavelength different from the first wavelength. The light combining member 24 combines the red light LR and the green light GL with each other and outputs the white light (combined light) WL. The first diffuser 40 includes the substrate (first substrate) 41 having the diffusion surface (first diffusion surface) 45, which diffuses white light WL incident thereon and outputs the diffused white light WL, and the driver (first driver) 42, which rotates the substrate 41. The light collector 25 is disposed between the light combining member 24 and the first diffuser 40, and collects the white light WL at the diffusion surface 45 of the substrate 41 of the first diffuser 40. The collimator 26 parallelizes the white light WL output from the substrate 41 of the first diffuser 40. The second diffuser 1 disposed between the light collector 25 and the first diffuser 40, and temporally changes the state of the collected light spot (spot) SP of the white light WL at the diffusion surface 45.

In contrast to the illuminator 2 according to the present embodiment, the configuration that does not include the second diffuser 100 between the light collector 25 and the first t diffuser 40 is presented as the configuration of the illuminator of related art. In the illuminator 2 according to the present embodiment, the white light WL to be radiated to the diffusion surface 45 of the substrate 41 of the first diffuser 40 is diffused by any one of the protruding and recessed structures 131, 132, 133, and 134 formed at the diffusion surface 121 of the substrate 110A of the second diffuser 100. In the illuminator 2 according to the present embodiment, the white light WL that produces a smaller amount of speckle noise than the speckle noise produced by the illuminator of related art, which does not includes the second diffuser 100, enters the optical integration system 50 disposed downstream from the first diffuser 40, that is, at the side where the white light WL is projected. The illuminator 2 according to the present embodiment can therefore favorably reduce the speckle noise that appears in a projection image when the white light WL output from the illuminator 2 is projected.

The illuminator of related art may have another configuration in which a diffuser that does not change with time the protruding and recessed structure of the diffusion surface or the state of the white light WL diffused by the diffusion surface is provided between the light collector 25 and the first diffuser 40. In this configuration, the speckle pattern in the collected light spot SP of the white light WL incident on the diffusion surface 45 of the substrate 41 of the first diffuser 40 does not change with time. In the illuminator 2 according to the present embodiment, the white light WL that produces a temporally changed speckle noise the amount of which is more quickly reduced than the speckle noise produced by an illuminator of related art that does not includes the second diffuser 100 enters the optical integration system 50 disposed downstream from the first diffuser 40. The illuminator 2 according to the present embodiment can therefore more favorably reduce the speckle noise that appears in a projection image when the white light WL output from the illuminator 2 is projected.

In the illuminator 2 according to the present embodiment, the second diffuser 100 includes the substrate (second substrate) 110A and the driver (second driver) 111. The substrate 110A diffusively transmits the white light WL incident thereon. The driver 111 rotates the substrate 110A in the rotational direction DS. The substrate 110A has the diffusion surface 121, which diffusively transmits the white light WL incident thereon. The diffusion surface 121 has at least a plurality of types of protruding and recessed structures along the rotational direction DS, and has, for example, the first region R1 provided with the protruding and recessed structure (first protruding and recessed structure) 131, and the second region R2 provided with the protruding and recessed structure (second protruding and recessed structure) 132 different from the protruding and recessed structure 131.

In the illuminator 2 according to the present embodiment, when the driver 111 rotates the substrate 110A in the rotational direction DS, the first region R1 and the second region R2 irradiated with the white light WL incident on the diffusion surface 121 are temporally switched from one to the other, and the protruding and recessed structures 131 and 132 on which the white light WL is incident are temporally switched from one to the other. The switching operation described above can therefore temporally change the diffusion, scattering, or diffraction pattern and the speckle pattern of the collected light spot SP of the white light WL formed at the diffusion surface 45 of the substrate 41 of the first diffuser 40. The illuminator 2 according to the present embodiment allows the white light WL that produces a temporally changed speckle noise the amount of which is quickly reduced to enter the optical integration system 50, so that the speckle noise that appears in a projection image based on the white light WL can be more favorably reduced.

In the illuminator 2 according to the present embodiment, the state of the collected light spot SP at the diffusion surface 45 of the first diffuser 40 changes at a frequency higher than or equal to 60 [Hz] as the substrate 110A of the second diffuser 100 rotates.

In the illuminator 2 according to the present embodiment, the diffusion surface 121 of the substrate 110A of the second diffuser 100 has, for example, the first region R1 and the second region R2, and further has the third region R3 and the fourth region R4. In the illuminator 2 according to the present embodiment, the first region R1, the second region R2, the third region R3, and the fourth region R4 of the diffusion surface 121 of the substrate 110A of the second diffuser 100, on which the white light WL is incident, are discontinuously switched one to another at a frequency higher than or equal to 60 [Hz]. Accordingly, the diffusion, scattering, or diffraction pattern of the collected light spot SP and the speckle pattern of the white light WL incident on the diffusion surface 45 of the substrate 41 of the first diffuser 40 are discontinuously switched at the frequency higher than or equal to 60 [Hz]. In the illuminator 2 according to the present embodiment, it is difficult for an observer of a projection image based on the white light WL to recognize blinking or flicker of the image caused by the speckle noise.

In the illuminator 2 according to the present embodiment, the number of regions of the diffusion surface 121 of the substrate 110A of the second diffuser 100 is not limited to four, and is any natural number m greater than or equal to two. For example, it is assumed that regions in which different protruding and recessed structures are formed at the diffusion surface 121 are divided into m equal portions in the rotational direction DS, and that the diffusion, scattering, or diffraction pattern and the speckle pattern of the collected light spot SP of the white light WL incident on the diffusion surface 45 are switched at a frequency ct [Hz] or higher. In this case, the rotation speed achieved by the driver 111 may be set at a value greater than or equal to 1/(ct×m) [revolutions/second]. The frequency ct [Hz] may be so adjusted that m is a natural number as described above.

The projector 1 according to the present embodiment includes the illuminator 2 described above, the light modulators 4R, 4G, and 4B, and the projection system 6. The light modulator 4R modulates the red light RL contained in the white light WL output from the illuminator 2 to generate the red image light. The light modulator 4G modulates the green light GL contained in the white light WL to generate the green image light. The light modulator 4B modulates the blue light BL contained in the white light WL to generate the blue image light. The projection system 6 projects the image light modulated by the light modulators 4R, 4G, and 4B.

In the projector 1 according to the present embodiment, the illuminator 2 includes the second diffuser 100 in addition to the first diffuser 40. The projector 1 according to the present embodiment can favorably reduce speckle noise that appears in a projection image when the white light WL output from the illuminator 2 is converted into the image light by the light modulators 4R, 4G, and 4B and the image light is projected onto the screen SCR.

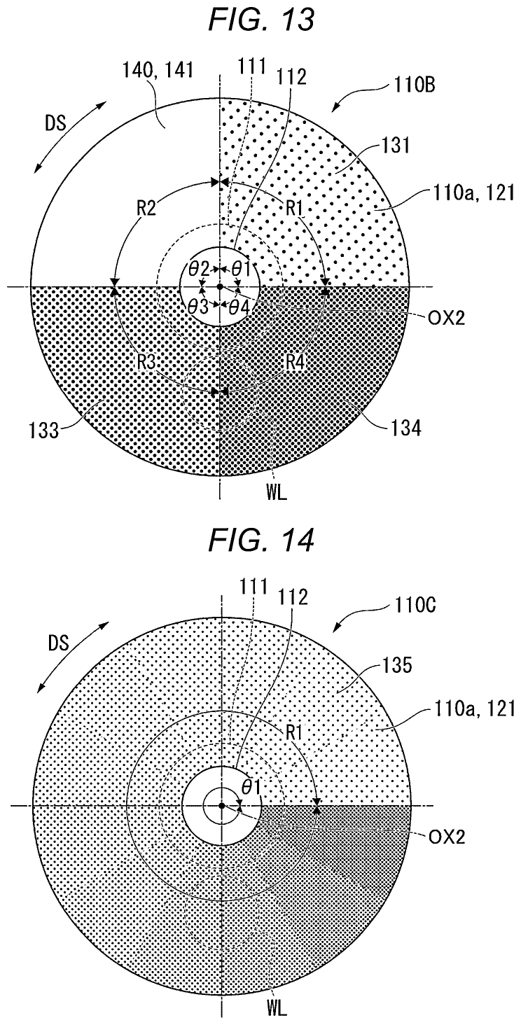

Variations of the substrate 110A of the second diffuser 100 in the illuminator 2 according to the present embodiment will be subsequently described with reference to FIGS. 13 to 15. In the description of each of the variations, the contents common to a variation already described are omitted, and configurations and contents different from those of the variation already described are described.

### First Variation

FIG. 13 is a schematic view of a substrate 110B according to a first variation of the second diffuser 100, and shows the substrate 110B viewed from the side facing the light incident surface 110a along the axis of rotation OX2. In the first variation, one of the first region R1, the second region R2, the third region R3, and the fourth region R4 of the diffusion surface 121 of the substrate 110A of the second diffuser 100 in the embodiment described above may be a non-diffusion surface 141. The substrate 110B is the first variation of the substrate 110A. The non-diffusion surface 141 is provided at the second region R2 of the substrate 110B shown in FIG. 13. The non-diffusion surface 141 does not diffuse but transmits the white light WL incident thereon. The non-diffusion surface 141 is, for example, a flat surface 140, at which no protruding and recessed structure is formed.

In the first variation of the illuminator 2 according to the present embodiment, the second diffuser 100 includes the substrate 110B and the driver (second driver) 111. The substrate 110B diffusively transmits the white light WL incident thereon. The driver 111 rotates the substrate 110B in the rotational direction DS. The substrate 110B has the diffusion surface 121, which diffusively transmits the white light WL incident thereon, and the non-diffusion surface 141, which is disposed at a position different from the position of the diffusion surface 121 in the rotational direction DS and transmits the white light WL. The diffusion surface 121 has at least one type of protruding and recessed structure along the rotational direction DS, and has the first region R1 provided, for example, with the protruding and recessed structure 131. The diffusion surface 121 of the substrate 110B has the third region R3 provided with the protruding and recessed structure 133 different from the protruding and recessed structure 131, and the fourth region R4 provided with the protruding and recessed structure 134 different from the protruding and recessed structure 131. The non-diffusion surface 141 has a flat second region R2, which does not diffuse the white light WL.

In the first variation of the illuminator 2 according to the present embodiment, when the driver 111 rotates the substrate 110B in the rotational direction DS, the first region R1 and the second region R2 irradiated with the white light WL incident on the diffusion surface 121 are temporally switched from one to the other, and the protruding and recessed structures 131 in the first region R1 and the flat surface 140 in the second region R2, on which the white light WL is incident, are temporally switched from one to the other. The switching operation described above can therefore temporally change the diffusion, scattering, or diffraction pattern and the speckle pattern of the collected light spot SP of the white light WL formed at the diffusion surface 45 of the substrate 41 of the first diffuser 40, as in the case where the substrate 110A is provided. The first variation of the illuminator 2 according to the present embodiment allows the white light WL that produces a temporally changed speckle noise the amount of which is quickly reduced to enter the optical integration system 50, so that the speckle noise that appears in a projection image based on the white light WL can be more favorably reduced.

As another variation of the substrate 110B that is not shown, for example, the non-diffusion surface 141 may be provided in any one of the first region R1, the third region R3, and the fourth region R4, and the protruding and recessed structure 132 may be provided in the second region R2. As still another variation of the substrate 110B that is not shown, when viewed along the axis of rotation OX2, the diffusion surface 121 and a protruding and recessed structure may be provided in two regions disposed at opposite sides of the axis of rotation OX2 out of the first region R1, the third region R3, and the fourth region R4, and the flat surface 140 may, for example, be provided as the non-diffusion surface 141 in each of the remaining two regions.

Still another variation of the substrate 110B that is not shown may be a substrate that has regions which are segmented in the rotational direction DS and the number of which is greater than or equal to two but is not four, and causes the states of the white light WL diffused by regions adjacent to each other in the rotational direction DS to differ from each other. The thus configured substrate is provided with the non-diffusion surface 141 in at least one of the plurality of regions. When the number of regions segmented in the rotational direction DS is greater than or equal to five, the non-diffusion surface 141 may be provided in two or more regions, and the diffusion surface 121 is provided in one or more regions between the non-diffusion surfaces 141 provided in the two regions in the rotational direction DS.

### Second Variation

FIG. 14 is a schematic view of a substrate 110C according to a second variation of the second diffuser 100, and shows the substrate 110C viewed from the side facing the light incident surface 110a along the axis of rotation OX2. In the second variation, the light incident surface 110a and the diffusion surface 121 of the substrate 110C of the second diffuser 100 are not segmented into a plurality of regions in the rotational direction DS, and have only the first region R1. The substrate 110C is the second variation of the substrate 110A. The angle θ1 of the first region R1 is 360°. A protruding and recessed structure 135 is formed in the first region R1 of the substrate 110C. The state of the incident white light WL diffused by the protruding and recessed structure 135 continuously changes along the rotational direction DS. In the protruding and recessed structure 135, for example, the heights of the protrusions and the depth of the recesses and the interval between the protrusions and the recesses continuously change along the rotational direction DS.

In the second variation of the illuminator 2 according to the present embodiment, the diffusion surface 121 of the substrate 110C of the second diffuser 100 has only the first region R1. In the second variation, in the first region R1, where the white light WL is incident on the diffusion surface 121 of the substrate 110C of the second diffuser 100, the diffusion state of the white light WL diffused by the protruding and recessed structure continuously changes in the rotational direction DS in the cycle of one revolution of the substrate 110C. Accordingly, the diffusion, scattering, or diffraction pattern and the speckle pattern of the collected light spot SP of the white light WL incident on the diffusion surface 45 of the substrate 41 of the first diffuser 40 are continuously switched in the cycle of one revolution of the substrate 110C. The second variation of the illuminator 2 according to the present embodiment can provide the same effects and advantages as those provided by the illuminator 2 including the second diffuser 100 including the substrate 110A or 110B.

### Third Variation

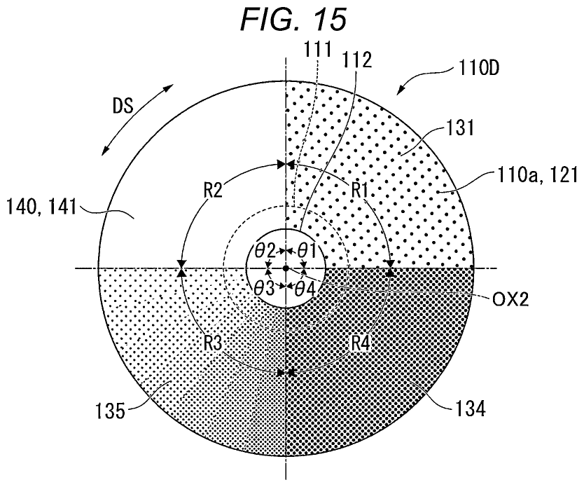

FIG. 15 is a schematic view of a substrate 110D according to a third variation of the second diffuser 100, and shows the substrate 110D viewed from the side facing the light incident surface 110a along the axis of rotation OX2. The substrate 110D according to the third variation is a variation of the substrate 110B of the first variation and is provided with the protruding and recessed structure 135 formed in the third region R3 in place of the protruding and recessed structure 133, as shown in FIG. 15. The substrate 110D is a third variation of the substrate 110A. Including the configuration of the substrate 110D, the light incident surface 110a of the substrate 110D may have the diffusion surface 121 that causes the state of the diffused white light WL to discontinuously change in the rotational direction DS, the diffusion surface 121 that causes the diffusion state to continuously change, and the non-diffusion surface 141 that does not diffuse the white light WL. The third variation of the illuminator 2 according to the present embodiment can provide the same effects and advantages as those provided by the illuminator 2 including the second diffuser 100 including the substrate 110A, 110B, or 110C.

A preferable embodiment of the present disclosure has been described above in detail. The present disclosure is, however, not limited to a specific embodiment, and a variety of modifications and changes can be made to the embodiment within the scope of the substance of the present disclosure described in the claims.

For example, the shapes, the numbers, the arrangements, the materials, and other factors of the components of the illuminator and the projector are not limited to those described in the aforementioned embodiment and variations thereof, and may be changed as appropriate.

In the embodiment described above, which describes the illuminator according to the present disclosure, an example of the reflective diffuser has been presented as the first diffuser, but not necessarily. For example, the illuminator according to the present disclosure may include a transmissive diffuser as the first diffuser. In this case, the substrate of the first diffuser is provided with no reflective film. The combined light having been diffused by the diffusion surface of the substrate of the first diffuser and having passed through the substrate is output via the light exiting surface of the substrate along the optical axis that coincides with the optical axis of the combined light incident on the substrate. In the embodiment described above, in which the first diffuser is a reflective diffuser, the disturbance of the polarization of the combined light output from the first diffuser is smaller than the disturbance that occurs in a transmissive diffuser.

In the embodiment described above, the illuminator according to the present disclosure has been described with reference to the case where the diffusion surface of the second diffuser is formed of the light incident surface of the substrate of the second diffuser, but not necessarily. For example, the diffusion surface of the second diffuser may be formed of the light exiting surface of the substrate of the second diffuser, or may be formed of both the light incident surface and the light exiting surface of the substrate of the second diffuser.

The aforementioned embodiment has been described with reference to the case where the illuminator according to the present disclosure is incorporated in a projector using liquid crystal panels, but not necessarily. For example, the illuminator according to the present disclosure may be used in a projector using a digital micromirror device as each of the light modulators. The projector according to the present disclosure may not include a plurality of light modulators and may instead be a single-panel projector including only one light modulator.

### SUMMARY OF PRESENT DISCLOSURE

The present disclosure will be summarized below as additional remarks. Additional remark 1: An illuminator including a first light source that outputs first light having a first wavelength; a second light source that outputs second light having a second wavelength different from the first wavelength; a light combining member that combines the first light and the second light with each other and outputs the combined light; a first diffuser including a first substrate having a first diffusion surface that diffuses the combined light incident thereon and outputs the diffused combined light, and a first driver that rotates the first substrate; a light collector that is disposed between the light combining member and the first diffuser and collects the combined light at the first diffusion surface of the first diffuser; a collimator that parallelizes the combined light output from the first diffuser; and a second diffuser that is disposed between the light collector and the first diffuser and temporally changes the state of a spot of the combined light at the first diffusion surface.

The configuration described in the additional remark 1 allows the combined light that produces reduced speckle noise, as compared with the speckle noise produced in a configuration in which the second diffuser is not provided or a configuration in which the second diffuser does not change the diffusion state of the incident combined light with time, to enter the optical system downstream from the first diffuser. The configuration described in the additional remark 1 can therefore favorably reduce the speckle noise that appears in a projection image when the combined light output from the illuminator is projected.
Additional remark 2: The illuminator described in the additional remark 1, in which the second diffuser includes a second substrate that diffuses the combined light incident thereon and outputs the diffused combined light, and a second driver that rotates the second substrate, the second substrate has a second diffusion surface that diffusively transmits the combined light incident thereon, and the second diffusion surface has a first region provided with a first protruding and recessed structure and a second region provided with a second protruding and recessed structure different from the first protruding and recessed structure.

According to the configuration described in the additional remark 2, when the second substrate is rotated by the second driver, the first region and the second region irradiated with the combined light incident on the second diffusion surface are temporally switched from one to the other, so that the diffusion surface on which the combined light is incident is temporally switched. The switching operation described above can therefore temporally change the diffusion, scattering, or diffraction pattern and the speckle pattern of the combined light spot formed at the first diffusion surface.
Additional remark 3: The illuminator described in the additional remark 1, in which the second diffuser includes a second substrate that diffuses the combined light incident thereon and outputs the diffused combined light, and a second driver that rotates the second substrate, the second substrate has a second diffusion surface that diffusively transmits the combined light incident thereon, and a non-diffusion surface that is disposed at a position different from the position of the second diffusion surface, the second diffusion surface has a first region provided with a protruding and recessed structure, and the non-diffusion surface has a flat second region that does not diffuse the combined light.

According to the configuration described in the additional remark 3, when the second substrate is rotated by the second driver, the first region and the second region irradiated with the combined light incident on the second diffusion surface are temporally switched from one to the other, so that the diffusion surface and the non-diffusion surface, on both of which the combined light is incident, are temporally switched. The switching operation described above can therefore temporally change the diffusion, scattering, or diffraction pattern and the speckle pattern of the combined light spot formed at the first diffusion surface.
Additional remark 4: The illuminator according to any one of additional remarks 1 to 3, in which the state of the spot at the first diffusion surface of the first diffuser changes at a frequency higher than or equal to 60 Hz when a second substrate that diffuses the combined light incident thereon and outputs the diffused combined light rotates in the second diffuser.

The configuration described in the additional remark 4 discontinuously switches the diffusion, scattering, or diffraction pattern and the speckle pattern of the combined light spot incident on the first diffusion surface at the frequency higher than or equal to 60 [Hz]. The configuration described in the additional remark 4 does not cause an observer of a projection image based on the combined light to recognize blinking or flicker of the image caused by the speckle noise.
Additional remark 5: A projector including the illuminator described in any one of the additional remarks 1 to 4, a light modulator that modulates light output from the illuminator, and a projection system that projects the light modulated by the light modulator.

The configuration described in the additional remark 5 can favorably reduce the speckle noise that appears in a projection image when the combined light output from the illuminator is converted by the light modulator and the image light is projected.

What is claimed is:

1. An illuminator comprising:
a first light source that emits first light having a first wavelength;
a second light source that emits second light having a second wavelength different from the first wavelength;
a light combining member that combines the first light and the second light with each other and emits combined light;
a first diffuser including a first substrate having a first diffusion surface that diffuses the combined light incident thereon and emits diffused combined light, and a first driver that rotates the first substrate;
a light collector that is disposed between the light combining member and the first diffuser and collects the combined light at the first diffusion surface of the first diffuser;
a collimator that parallelizes the combined light emitted from the first diffuser; and
a second diffuser that is disposed between the light collector and the first diffuser and temporally changes a state of a spot of the combined light at the first diffusion surface.

2. The illuminator according to claim 1, wherein
the second diffuser includes a second substrate that diffuses the combined light incident thereon and emits the diffused combined light, and a second driver that rotates the second substrate,
the second substrate has a second diffusion surface that diffusively transmits the combined light incident thereon, and
the second diffusion surface has a first region provided with a first protruding and recessed structure and a second region provided with a second protruding and recessed structure different from the first protruding and recessed structure.

3. The illuminator according to claim 1, wherein
the second diffuser includes a second substrate that diffuses the combined light incident thereon and emits the diffused combined light, and a second driver that rotates the second substrate,
the second substrate has a second diffusion surface that diffusively transmits the combined light incident thereon, and a non-diffusion surface that is disposed at a position different from the position of the second diffusion surface and transmits the combined light,
the second diffusion surface has a first region provided with a protruding and recessed structure, and
the non-diffusion surface has a flat second region that does not diffuse the combined light.

4. The illuminator according to claim 1, wherein
the state of the spot at the first diffusion surface of the first diffuser changes at a frequency higher than or equal to 60 Hz when a second substrate that diffuses the combined light incident thereon and emits the diffused combined light rotates in the second diffuser.

5. A projector comprising:
the illuminator according to claim 1;
a light modulator that modulates light emitted from the illuminator; and
a projection system that projects the light modulated by the light modulator.
